(19) United States
(12) Patent Application Publication
(10) Pub. No.: US 2017/0256087 A1
(43) Pub. Date: Sep. 7, 2017

(54) METHOD FOR PROVIDING ANIMATION EFFECT AND ELECTRONIC DEVICE THEREOF

(71) Applicant: Samsung Electronics Co., Ltd., Suwon-si (KR)

(72) Inventors: Min-Hee LEE, Seoul (KR); Hangyul KIM, Seoul (KR); Hoyoung LEE, Seoul (KR)

(21) Appl. No.: 15/449,378

(22) Filed: Mar. 3, 2017

(30) Foreign Application Priority Data
Mar. 3, 2016 (KR) 10-2016-0025550

(51) Int. Cl. G06T 13/80

(52) U.S. Cl. CPC G06T 13/80; G06T 2213/12

(57) ABSTRACT

An apparatus and a method for providing an animation effect on a looper function in an electronic device are provided. The electronic device includes a display configured to display a looper screen that includes a plurality of loop items, a memory configured to store a plurality of sound samples corresponding to the loop items, and at least one processor. The at least one processor is further configured to select at least one loop item from among the plurality of loop items displayed on the display, determine an animation corresponding to an attribute of the at least one loop item, and play the animation corresponding to the attribute of the at least one loop item.

### CROSS-REFERENCE TO RELATED APPLICATION(S)

This application claims the benefit under 35 U.S.C. §119(a) of a Korean patent application filed on Mar. 3, 2016 in the Korean Intellectual Property Office and assigned Serial number 10-2016-0025550, the entire disclosure of which is hereby incorporated by reference.

### TECHNICAL FIELD

The present disclosure relates to an apparatus and a method for providing an animation effect on a looper function in an electronic device.

### BACKGROUND

With the growth of information telecommunication technologies and semiconductor technologies, various electronic devices are developing into multimedia devices providing various multimedia services. For example, the electronic device can provide various multimedia services, such as a mobile communication service, a data communication service, a broadcasting service, a camera service, an audio play service, and the like.

As the use of the multimedia services in the electronic device increases, information quantitation that should be processed in the electronic device and information quantitation that should be displayed are increasing. Accordingly to this, attention is being increasingly paid to an electronic device with a touch screen capable of improving a space utilization and increasing the size of a display unit.

The touch screen can perform information input and display in one screen. Accordingly to this, the electronic device can output a display screen through the touch screen. In addition, the electronic device can control the display screen based on touch information that is detected through the touch screen.

The above information is presented as background information only to assist with an understanding of the present disclosure. No determination has been made, and no assertion is made, as to whether any of the above might be applicable as prior art with regard to the present disclosure.

### SUMMARY

In case where an electronic device is equipped with a touch screen, the electronic device does not provide various interactions for various touch motions. Owing to this, the electronic device has a problem in which a use efficiency of the touch screen and a user convenience are low because the control of a display screen corresponding to the various touch motions is restricted.

Aspects of the present disclosure are to address at least the above-mentioned problems and/or disadvantages and to provide at least the advantages described below. Accordingly, an aspect of the present disclosure is to provide an apparatus and a method for providing various interactions for touch motions in an electronic device.

In accordance with an aspect of the present disclosure, an electronic device is provided. The electronic device includes a display configured to display a looper screen that includes a plurality of loop items, a memory configured to store a plurality of sound samples corresponding to the loop items, and at least one processor. The at least one processor can be set to select at least one loop item from among the plurality of loop items displayed on the display, determine an animation corresponding to an attribute of the at least one loop item, and play the animation corresponding to the attribute of the at least one loop item.

In accordance with another aspect of the present disclosure, a method for operating in an electronic device is provided. The method includes the operations of displaying a looper screen that includes a plurality of loop items, selecting at least one loop item from among the plurality of loop items displayed on the looper screen, determining an animation corresponding to an attribute of the at least one loop item, and playing the animation corresponding to the attribute of the at least one loop item.

In accordance with another aspect of the present disclosure, an electronic device is provided. The electronic device includes a display configured to display a looper screen that includes a plurality of loop items, a memory storing a plurality of animations that is available to be set to the loop items, and at least one processor. The at least one processor can be set to select any one loop item from among the plurality of loop items displayed on the display, determine at least one animation corresponding to an attribute of the selected any one loop item, and set any one animation among the at least one animation, as an animation corresponding to the attribute of the loop item.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates a block diagram of an electronic device according to an embodiment of the present disclosure;

FIG. 1B illustrates a block diagram of an electronic device for providing a looper function according to an embodiment of the present disclosure;

FIG. 2 illustrates a flowchart for providing an animation effect of a loop item in an electronic device according to an embodiment of the present disclosure;

FIG. 3 illustrates a service screen of a looper function according to an embodiment of the present disclosure;

FIG. 4 illustrates a flowchart for selecting an animation effect of a loop item in an electronic device according to an embodiment of the present disclosure;

FIG. 5 illustrates a flowchart for determining an animation effect of a loop item in an electronic device according to an embodiment of the present disclosure;

FIG. 6 illustrates a flowchart for playing an animation of a loop item in an electronic device according to an embodiment of the present disclosure;

FIGS. 7A, 7B, 7C, 7D, and 7E illustrate animation effects of loop items according to various embodiments of the present disclosure;

FIGS. 8A and 8B illustrate groups of loop items for applying animation effects according to various embodiments of the present disclosure;

FIG. 9 illustrates a flowchart for setting an animation of a loop item in an electronic device according to an embodiment of the present disclosure;

FIG. 10 illustrates a flowchart for providing an animation list corresponding to a loop item in an electronic device according to an embodiment of the present disclosure;

FIG. 11 illustrates a flowchart for setting an animation of a loop item in an electronic device according to an embodiment of the present disclosure; and

FIGS. 12A and 12B illustrate screen constructions for setting an animation of a loop item in an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In embodiments of the present disclosure, an expression “A or B”, “A and/or B”, and the like may include all possible combinations of items enumerated together. Although expressions, such as “1^{st}”, “2^{nd}”, “first”, and “second” may be used to express corresponding constitutional elements, it is not intended to limit the corresponding constitutional elements. When a certain (e.g., 1^{st}) constitutional element is mentioned as being “operatively or communicatively coupled with/to” or “connected to” a different (e.g., 2^{nd}) constitutional element, the certain constitutional element is directly coupled with/to another constitutional element or can be coupled with/to the different constitutional element via another (e.g., 3^{rd}) constitutional element.

An expression “configured to” used in embodiments of the present disclosure may be interchangeably used with, for example, “suitable for”, “having the capacity to”, “adapted to”, “made to”, “capable of”, or “designed to” in a hardware or software manner according to a situation. In a certain situation, an expressed “a device configured to” may imply that the device is “capable of” together with other devices or components. For example, “a processor configured to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in a memory device.

An electronic device according to various embodiments of the present disclosure can, for example, include at least one of a smart phone, a tablet personal computer (PC), a mobile phone, a video phone, an electronic book reader, a desktop PC, a laptop PC, a netbook computer, a workstation, a server, a portable digital assistant (PDA), a portable multimedia player (PMP), a moving picture experts group phase 1 (MPEG-1) audio layer-3 (MP3) player, a mobile medical device, a camera, a wearable device, and the like.

In various embodiments, the electronic device can be flexible, or be a combination of two or more of the aforementioned various devices. The electronic device according to an embodiment of the present disclosure is not limited to the aforementioned devices. In an embodiments of the present disclosure, the term ‘user’ can denote a person who uses the electronic device or a device (e.g., artificial-intelligent electronic device) which uses the electronic device.

In the following description, a looper function can include a music application that can generate a performance or effect sound of a virtual instrument in the electronic device. For example, the electronic device can play a sound sample assigned (or registered) to a corresponding loop item, based on a selection input of a plurality of loop items included in a looper screen (or looper function). Here, the sound sample assigned to the loop item can have a mutually different attribute. For instance, the attribute can be determined according to at least any one of a genre, an instrument or a mood. Accordingly to this, a user of the electronic device can play music or compose music independently of or in combination of the sound samples assigned to the loop items included in the looper screen.

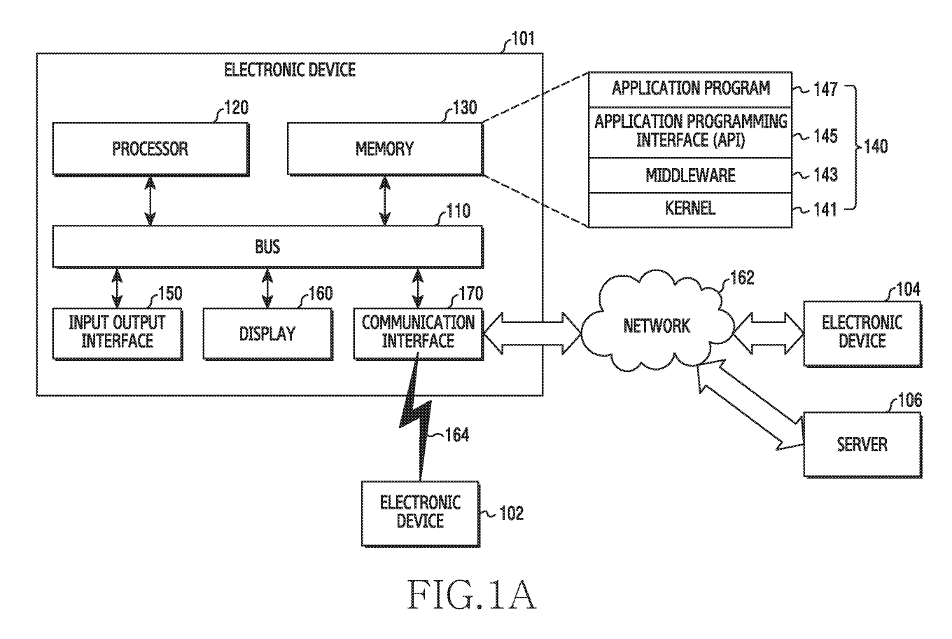

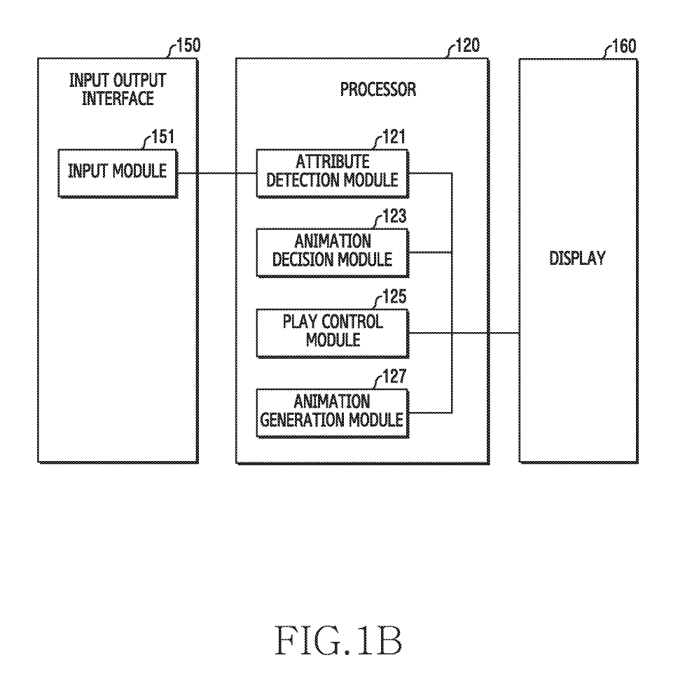

FIG. 1A illustrates a block diagram of an electronic device according to various embodiments of the present disclosure.

Referring to FIG. 1A, an electronic device 101 can include a bus 110, a processor 120 (e.g., including processing circuitry), a memory 130, an input output interface 150 (e.g., including input/output circuitry), a display 160 (e.g., including display circuitry), and a communication interface 170 (e.g., including communication circuitry). In some embodiments of the present disclosure, the electronic device 101 can omit at least one of the constituent elements or additionally have another constituent element.

The bus 110 can, for example, include a circuit coupling the constituent elements 120 to 170 with one another and forwarding communication (e.g., a control message and/or data) between the constituent elements.

The processor 120 can include one or more of a CPU, an application processor (AP), or a communication processor (CP). The processor 120 can, for example, execute operation or data processing for control and/or communication of at least one another constituent element of the electronic device 101.

According to an embodiment of the present disclosure, the processor 120 can control to provide a looper function. For example, the processor 120 can control to display a looper screen including a plurality of loop items through the display 160. In case where at least one loop item is selected based on input information detected through the input output interface 150, the processor 120 can control to play a sound sample registered to the at least one loop item. For instance, the loop item is an object which a sound sample to play through the looper function is registered to, and can be called a pad or cell as well.

According to an embodiment of the present disclosure, the processor 120 can control to provide an animation corresponding to an attribute of a loop item. For example, in case where the processor 120 plays a sound sample registered to a loop item, the processor 120 can determine an animation corresponding to an attribute of the corresponding loop item. The processor 120 can control to play the animation corresponding to the attribute of the loop item through the display 160. For instance, the attribute of the loop item can include at least one of a position of the loop item, a length of a sound sample assigned to the loop item and a performance attribute of the loop item. The performance attribute is a musical attribute of a performance interaction of the sound sample registered to the loop item. The performance attribute can include a playing scheme of the sound sample registered to the loop item.

The memory 130 can include a volatile and/or non-volatile memory. For example, the memory 130 can store an instruction or data (e.g., sound sample, animation) related to at least one another constituent element of the electronic device 101. According to an embodiment of the present disclosure, the memory 130 can store a software and/or program 140. For example, the program 140 can include a kernel 141, a middleware 143, an application programming interface (API) 145, an application program (or “application”) 147, and the like.

The input output interface 150 can, for example, play a role of an interface that can forward a command or data, which is inputted from a user or another external device, to another constituent element(s) of the electronic device 101. For example, the input output interface 150 can include a touch panel detecting a touch input or hovering input that uses an electronic pen or a part of the user's body.

The display 160 can display various contents (e.g., a text, an image, a video, an icon, a symbol, and the like) to a user. For example, the display 160 can include a liquid crystal display (LCD), a light emitting diode (LED) display, an organic LED (OLED) display, or a microelectromechanical systems (MEMS) display, or an electronic paper display. For example, the display 160 can be combined with a touch panel of the input output interface 150, to be implemented as a touch screen.

The communication interface 170 can establish communication between the electronic device 101 and an external device (e.g., a 1st external electronic device 102, a 2nd external electronic device 104, a server 106 or a satellite). For example, the communication interface 170 can be coupled to a network 162 through wireless communication or wired communication, and communicate with the external device (e.g., the 2nd external electronic device 104 or the server 106). For instance, the wireless communication can include a cellular communication that uses at least one of long term evolution (LTE), LTE-advanced (LTE-A), code division multiple access (CDMA), wideband CDMA (WCDMA), universal mobile telecommunications system (UMTS), wireless broadband (WiBro), global system for mobile communications (GSM), and the like. For instance, the wireless communication 164 can include at least one of Wi-Fi, Bluetooth (BT), BT low energy (BLE), ZigBee, near field communication (NFC), magnetic secure transmission (MST), radio frequency (RF), body area network (BAN) or global navigation satellite system (GNSS). For instance, the wired communication can include at least one of a universal serial bus (USB), a high definition multimedia interface (HDMI), recommended standard-232 (RS-232), power line communication (PLC), plain old telephone service (POTS), and the like. For instance, the network 162 can include at least one of a telecommunications network, for example, a computer network (e.g., a local area network (LAN) or a wide area network (WAN)), the internet, or a telephone network.

FIG. 1B illustrates a block diagram of an electronic device for providing a looper function according to various embodiments of the present disclosure. The following description is made for a construction for applying an animation effect for a loop icon in the electronic device 101.

Referring to FIG. 1B, the electronic device 101 can include the processor 120, the input output interface 150, and the display 160 that are operatively coupled with one another.

According to an embodiment of the present disclosure, the input output interface 150 can include an input module 151. For example, the input module 151 can detect a selection input of at least one loop item for playing a sound sample in a looper screen displayed on the display 160. For instance, the selection input of the loop item can include at least one of a touch input and a pressure input in which the loop item displayed on the display 160 corresponds to a display region.

According to an embodiment of the present disclosure, the processor 120 can include an attribute detection module 121, an animation decision module 123, a play control module 125 and an animation generation module 127.

According to an embodiment of the present disclosure, the attribute detection module 121 can detect an attribute of at least one loop item that is selected based on input information detected through the input module 151. For example, the attribute detection module 121 can determine if a touch input on at least one loop item from among loop items included in a looper screen displayed on the display 160 is detected. The attribute detection module 121 can determine at least one of a position of at least one loop item on which a touch input is detected, a length (e.g., bit) of a sound sample registered to the loop item, and a performance attribute of the sound sample registered to the loop item.

According to an embodiment of the present disclosure, the animation decision module 123 can determine an animation corresponding to an attribute of a loop item. For example, the animation decision module 123 can detect at least one animation that is mapped to a loop item selected by the input module 151. The animation decision module 123 can select an animation corresponding to an attribute of the loop item from among the at least one animation mapped to the loop item. For example, the animation decision module 123 can select an animation corresponding to a performance attribute of the loop item from among the at least one animation mapped to the loop item. The animation decision module 123 can update the animation corresponding to the performance attribute based on at least one of a position of the loop item and a length of a sound sample registered to the loop item.

According to an embodiment of the present disclosure, the play control module 125 can control to play through the display 160 an animation of a loop item that is determined in the animation decision module 123. For example, in case where animations of a plurality of loop items are played, the play control module 125 can control the display 160 to display one animation based on the priority order of the loop items. For instance, the priority order of the loop item can be set based on at least one of a performance attribute of the loop item and a selection sequence of the loop item. For example, the play control module 125 can control the display 160 to overlap and display the animations of the plurality of loop items.

According to an embodiment of the present disclosure, the animation generation module 127 can generate an animation of a loop item based on input information detected through the input module 151. For example, the animation generation module 127 can determine if an animation generation event occurs based on the input information detected through the input module 151. Based on an attribute of a loop item to set an animation, the animation generation module 127 can control the display 160 to display a list of animations that are available to be mapped to the corresponding loop item. The animation generation module 127 can set an animation, which is selected from the animation list displayed on the display 160 based on the input information detected through the input module 151, as an animation of a corresponding loop item.

According to an embodiment of the present disclosure, the processor 120 can play a sound sample registered to at least one loop item that is selected based on input information detected through the input module 151. For example, the processor 120 can play a sound sample registered to a loop item of which a selection input is detected, through an audio processing module (not shown).

According to an embodiment of the present disclosure, the display 160 can display an animation effect corresponding to a loop item based on the control of the play control module 125. For example, the display 160 can change a graphic variable of at least one loop item to correspond to an animation that the play control module 125 has determined to play. For instance, the graphic variable can include a shadow of the loop item, a color thereof, a contour line thereof, a color of the contour line, and the like.

According to various embodiments of the present disclosure, the electronic device 101 can include at least some of the attribute detection module 121, the animation decision module 123, the play control module 125 and the animation generation module 127 that are included in the processor 120, as separate modules different from the processor 120, as well.

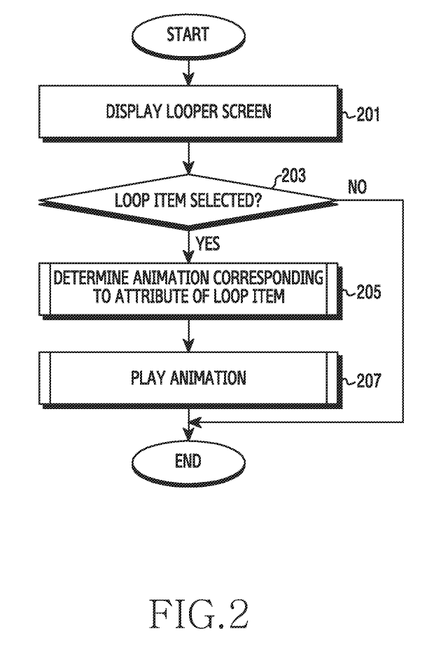

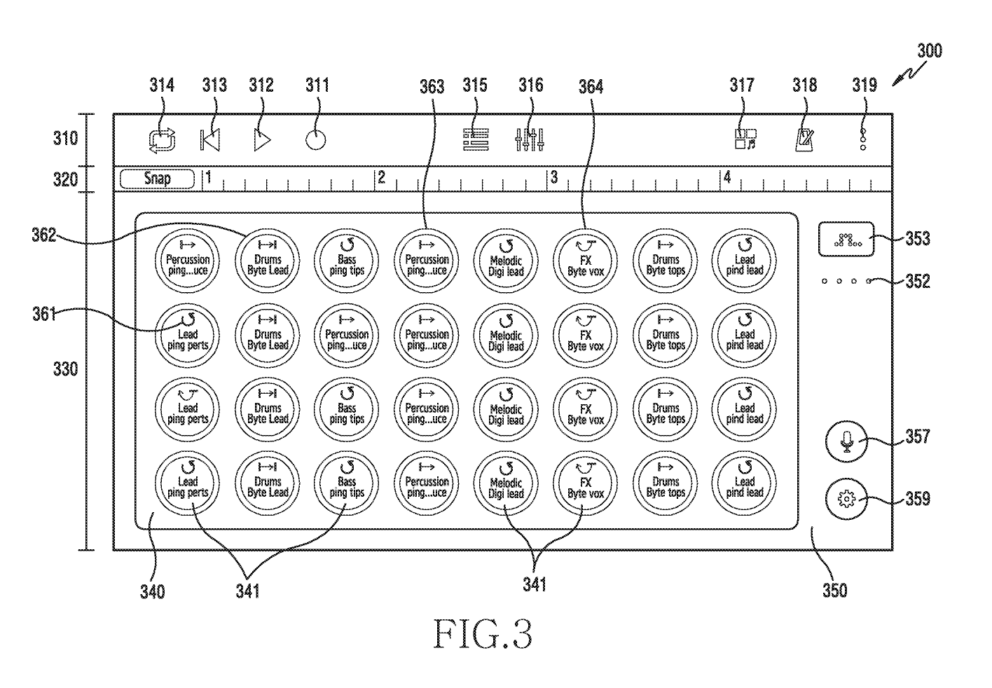

FIG. 2 illustrates a flowchart for providing an animation effect of a loop item in an electronic device according to an embodiment of the present disclosure. The following description is made for an operation of providing an animation effect of a loop item with reference to a looper screen illustrated in FIG. 3.

FIG. 3 illustrates a service screen of a looper function according to an embodiment of the present disclosure. In the following description, the electronic device can include the electronic device 101 of FIGS. 1A and 1B or at least a part (e.g., processor 120) of the electronic device 101.

Referring to FIG. 2, in operation 201, the electronic device can display a looper screen for performing a looper function on a display (e.g., display 160 of FIGS. 1A and 1B). For example, in case where an event corresponding to looper function execution occurs, as in FIG. 3, the processor 120 can display a looper screen 300 including a plurality of loop items 341 through the display 160. For instance, the event corresponding to the looper function execution can occur based on input information detected through the input output interface 150, a gesture input detected through a sensor (not shown) of the electronic device 101, and the like.

In operation 203, the electronic device can determine if at least one loop item is selected in the looper screen displayed on the display of the electronic device. For example, as in FIG. 3, in case where a touch input on the looper screen 300 displayed on the display 160 is detected, the processor 120 can determine if the touch input on the loop item 341 has been detected. For instance, the processor 120 can determine if the loop item 341 mapped to a position (e.g., coordinate) of the touch input detected through the input output interface 150 exists among the loop items 341 included in the looper screen 300 displayed on the display 160.

According to an embodiment of the present disclosure, in case where at least one loop item is not selected, the electronic device can terminate the present algorithm for providing the animation effect matched to the loop item.

In case where the at least one loop item is selected, in operation 205, the electronic device can determine an animation corresponding to an attribute of the selected loop item. For example, the processor 120 can determine if an animation mapped to the loop item 341 that is selected in operation 203 exists. In case where the animation mapped to the loop item 341 exists, the processor 120 can select an animation corresponding to an attribute of the loop item 341 among animations mapped to the loop items 341. For instance, the attribute of the loop item 341 can include at least one of a position of the loop item 341, a length of a sound sample registered to the loop item 341 and a performance attribute of the loop item 341. For example, the processor 120 can select an animation corresponding to the performance attribute of the loop item 341 among the at least one animation mapped to the loop item 341 that is selected in operation 203. The processor 120 can determine the animation corresponding to the attribute of the loop item 341 by updating the animation corresponding to the performance attribute of the loop item 341 to correspond to at least one of the position of the loop item 341 and the length of the sound sample registered to the loop item 341.

In operation 207, the electronic device can play the animation corresponding to the attribute of the loop item. For example, in case where the processor 120 plays animations corresponding to a plurality of loop items, the processor 120 can select any one animation based on the priority order of the loop items. The processor 120 can display through the display 160 the animation that is selected based on the priority order of the loop item, in synchronization with a time point of playing a sound sample of the loop item. For example, in case where the processor 120 plays the animations corresponding to the plurality of loop items, the processor 120 can overlap and display a plurality of the animations through the display 160. For instance, the processor 120 can sequentially or simultaneously change a graphic variable of at least one loop item included in a pattern of an animation, to correspond to an animation effect. The processor 120 can control the display 160 to repeatedly display an animation while keeping playing a sound sample registered to the loop item.

Referring to FIG. 3, the looper screen 300 can include a control region 310, a timeline region 320 and a looper execution region 330. For instance, although the looper screen 300 does not include the control region 310 and the timeline region 320, the present disclosure can be implemented.

According to an embodiment of the present disclosure, the control region 310 can be provided for the general control of a looper function. Here, the control region 310 can include a store icon 311, a play icon 312, a change icon 313, a duration repeat icon 314, an edit icon 315, a special icon 316, a genre icon 317, a beat indicator 318 and other icons 319. For example, the store icon 311 can be used to store, as a music file, a sound sample registered to the loop item 341. The play icon 312 can be used to play the music file. The change icon 313 can be used to change a play position of the music file. The duration repeat icon 314 can be used to repeat playing a constant duration of the music file. The edit icon 315 can be used to edit the music file. The special icon 316 can be used to apply a special effect to the music file. The genre icon 317 can be used to change a genre of the music file or a genre corresponding to the looper execution region 330. The beat indicator 318 can be used to display a beat of the music file. The other icons 319 can be used for other control of the looper function. The timeline region 320 can be provided to display a play position of the music file.

According to an embodiment of the present disclosure, the looper execution region 330 can include a loop region 340 and an icon region 350 for the sake of the execution of a loop region function. For example, loop items 341 can be arranged in a lattice structure of a plurality of columns and a plurality of rows. For example, the loop region 340 can include a plurality of the loop items 341 that are individually assigned sound samples. Here, the sound sample can have a mutually different attribute. For instance, the loop items 341 can be assigned sound samples of the same genre. In addition, the loop items 341 of the same row are assigned sound samples of the same mood, and the loop items 341 of the same column can be assigned sound samples of the same instrument. Additionally, the loop item 341 can have various forms. For instance, the loop items 341 can be constructed in a circular shape or polygonal shape.

According to an embodiment of the present disclosure, the loop item 341 can be individually assigned a performance attribute. For example, the performance attribute of the loop item 341 can include at least one of a continuous play, a single play, a resume play, and a repeat play, as a scheme of playing the sound sample registered to the loop item 341. For instance, the continuous play can include a scheme of continuously playing a sound sample registered to a loop item 363 while an input (e.g., touch) for the loop item 363 is maintained. For instance, the single play can include a scheme of, when an input (e.g., tap input) of a loop item 362 is detected, single playing a sound sample registered to the loop item 362. Additionally, the single play can stop the playing of the sound sample registered to the loop item 362 when an input of the corresponding loop item 362 is detected during the playing of the sound sample registered to the loop item 362. For instance, the resume play can include a scheme of repeatedly playing a sound sample registered to a loop item 364 to correspond to the number of input (e.g., tap input) of the loop item 364. For instance, the repeat play can include a scheme of, when an input (e.g., tap input) of a loop item 361 is detected, repeatedly playing a sound sample registered to the loop item 361. Additionally, the repeat play can stop the playing of the sound sample registered to the loop item 361 when the input of the corresponding loop item 361 is detected during the playing of the sound sample registered to the loop item 361. For instance, stopping the playing of the sound sample can include stopping the playing of a sound sample of a loop item at a time point of detecting an input of the loop item, or stopping additional playing after the completion of the playing of the sound sample registered to the loop item.

According to an embodiment of the present disclosure, the icon region 350 can include a record icon 357, a set-up icon 359, an effect icon 353 and a beat indicator 352. For instance, the record icon 357 can be used to register, as a sound sample of the loop item 341, an audio signal processed in the electronic device 101. The set-up icon 359 can be used to change the set-up of each loop item 341. The effect icon 353 can be used to apply an audio effect to at least one sound sample among sound samples registered to the loop items 341. The beat indicator 352 can be used to display a play beat of at least one sound sample among the sound samples registered to the loop items 341.

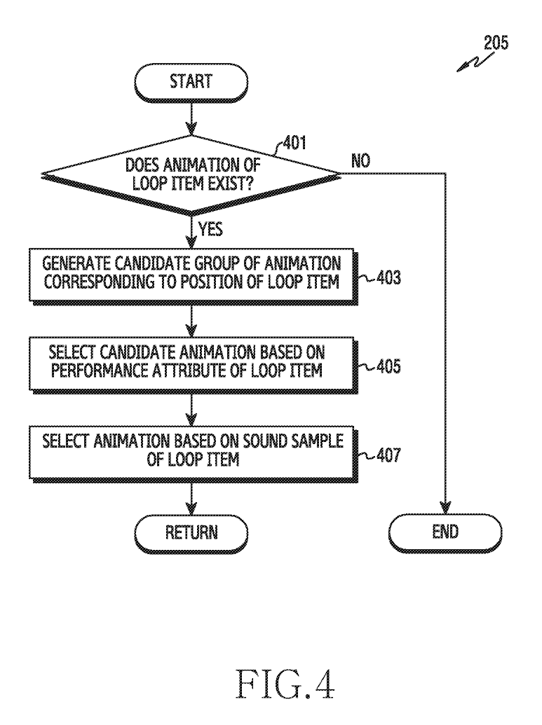

FIG. 4 illustrates a flowchart for selecting an animation effect of a loop item in an electronic device according to an embodiment of the present disclosure. The following description is made for an operation of selecting an animation effect of a loop item in operation 205 of FIG. 2. In the following description, the electronic device can include the electronic device 101 of FIGS. 1A and 1B or at least a part (e.g., processor 120) of the electronic device 101.

Referring to FIG. 4, in case where a selection input of a loop item is detected (e.g., operation 203 of FIG. 2), in operation 401, the electronic device can determine if at least one animation mapped to the loop item of which the selection input is detected exists. For example, the processor 120 can determine if animation information about the loop item of which the selected input is detected exists among animation information about loop items stored in the memory 130.

In case where the at least one animation mapped to the loop item of which the selection input is detected does not exist, the electronic device can determine that it cannot provide an animation effect of the loop item. Accordingly to this, the electronic device can terminate the present algorithm for providing the animation effect matched to the loop item.

In case where the at least one animation mapped to the loop item of which the selection input is detected exists, in operation 403, the electronic device can generate a candidate group of an animation corresponding to a position of the loop item. For example, the processor 120 can extract from the memory 130 the at least one animation mapped to the loop item of which the selection input is detected. For instance, the at least one animation mapped to the loop item can be set based on the position of the loop item. Accordingly to this, the processor 120 can generate a candidate group including at least one animation extracted from the memory 130, as the candidate group of the animation corresponding to the position of the loop item. For instance, the candidate group can include at least one animation that is set by performance attribute of a loop item and length of a sound sample registered to the loop item, based on a position of the corresponding loop item.

In operation 405, the electronic device can select at least one candidate animation from the candidate group of the animation corresponding to the position of the loop item, based on a performance attribute of the loop item. For example, in case where the performance attribute of the loop item that is selected by an input of the input module 151 is the single play (e.g., 362 of FIG. 3), the processor 120 can select at least one candidate animation corresponding to the performance attribute of the single play from the candidate group of the animation corresponding to the position of the loop item. For example, in case where the performance attribute of the loop item that is selected by the input of the input module 151 is the continuous play (e.g., 363 of FIG. 3), the processor 120 can select at least one candidate animation corresponding to the performance attribute of the continuous play from the candidate group of the animation corresponding to the position of the loop item. For instance, the candidate animation can include at least one animation that is set by length of the sound sample regarding the performance attribute of the loop item.

In operation 407, the electronic device can select an animation corresponding to the sound sample of the loop item from among the at least one candidate animation that is selected based on the performance attribute of the loop item. For example, the processor 120 can select an animation corresponding to a length (e.g., 1 bit) of a sound sample among the at least one candidate animation corresponding to the performance attribute of the loop item. For example, the processor 120 can group a length of the sound sample registered to the loop item, into a plurality of sample groups. For instance, the processor 120 can group 1 bit and 2 bits into a 1st sample group, and can group 4 bits and more into a 2nd sample group. The processor 120 can select an animation corresponding to a sample group including a length of a sound sample among the at least one candidate animation corresponding to the performance attribute of the loop item.

According to various embodiments, the electronic device can differently set a criterion of selecting a candidate animation and an animation. For example, the processor 120 can select at least one candidate animation from a candidate group corresponding to a position of a loop item, based on a length of a sound sample registered to the loop item. The processor 120 can select an animation corresponding to a performance attribute of the loop item from at least one candidate animation.

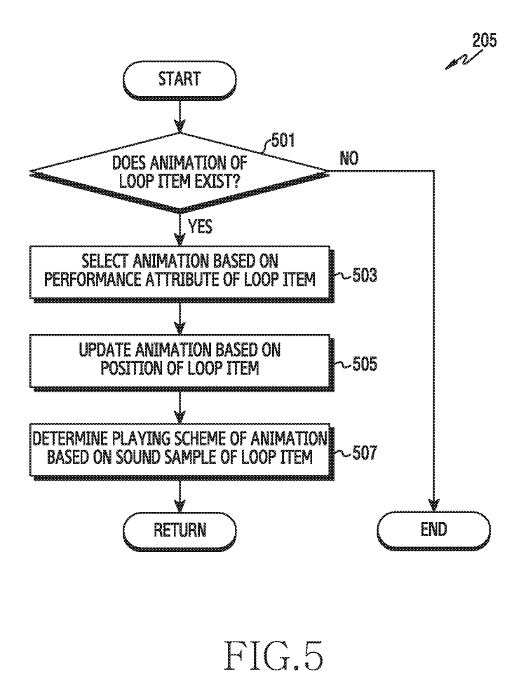

FIG. 5 illustrates a flowchart for deciding an animation effect of a loop item in an electronic device according to an embodiment of the present disclosure. The following description is made for an operation of deciding an animation effect of a loop item in operation 205 of FIG. 2. In the following description, the electronic device can include the electronic device 101 of FIGS. 1A and 1B or at least a part (e.g., processor 120) of the electronic device 101.

Referring to FIG. 5, if the electronic device detects a selection input for a loop item (e.g., operation 203 of FIG. 2), in operation 501, the electronic device can determine if at least one animation mapped to the loop item of which the selection input is detected exists. For example, the processor 120 can search the memory 130 and determine if an animation corresponding to the loop item selected by input information of the input module 151 exists.

If the at least one animation mapped to the loop item of which the selection input is detected does not exist, the electronic device can determine that it cannot provide an animation effect of the loop item. Accordingly to this, the electronic device can terminate the present algorithm for providing the animation effect matched to the loop item.

In case where the at least one animation mapped to the loop item of which the selection input is detected exists, in operation 503, the electronic device can select an animation corresponding to a performance attribute of the loop item. For example, the processor 120 can select the animation corresponding to the performance attribute (e.g., repeat play) of the loop item from among the at least one animation mapped to the loop item of which the selection input is detected.

In operation 505, the electronic device can update the animation corresponding to the performance attribute of the loop item, based on a position of the loop item of which the selection input is detected. For example, the processor 120 can detect the position of the loop item of which the selection input is detected, in a lattice array of loop items included in the loop region screen 300 of FIG. 3. The processor 120 can update the animation corresponding to the performance attribute of the loop item to correspond to the position of the loop item. For instance, the processor 120 can update the animation corresponding to the performance attribute of the loop item such that an animation begins at the position of the loop item, or the animation effect is applied centering on the position of the loop item.

In operation 507, the electronic device can determine, based on a sound sample of the loop item, a playing scheme of the animation that is updated based on the position of the loop item. For example, the processor 120 can determine a playing duration of the animation to correspond to a length of a sound sample registered to the loop item. For instance, the processor 120 can determine the playing duration of the animation short as the length of the sound sample registered to the loop item is short.

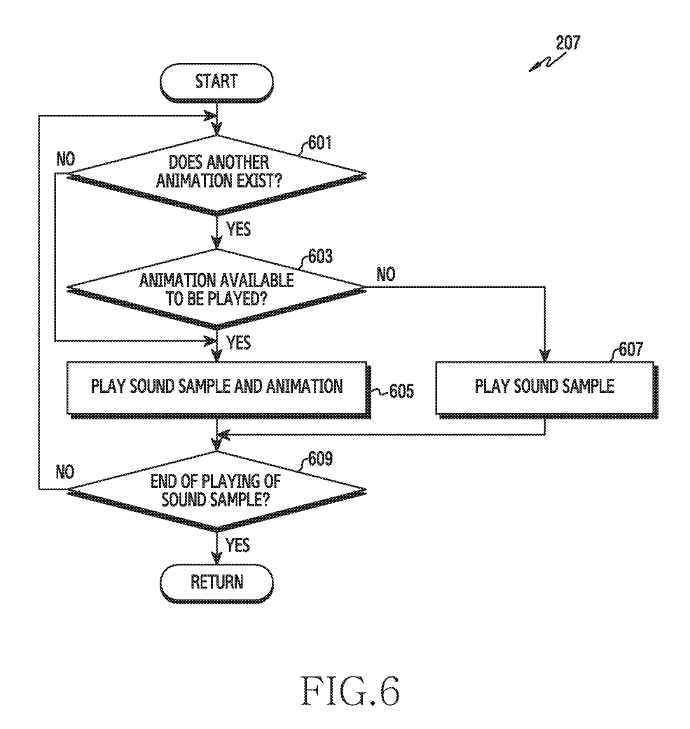

FIG. 6 illustrates a flowchart for playing an animation of a loop item in an electronic device according to an embodiment of the present disclosure. The following description is made for an operation of providing the animation of the loop item in operation 207 of FIG. 2. In the following description, the electronic device can include the electronic device 101 of FIGS. 1A and 1B or at least a part (e.g., processor 120) of the electronic device 101.

Referring to FIG. 6, if the electronic device determines an animation corresponding to an attribute of a loop item of which a selection input is detected (e.g., operation 205 of FIG. 2), in operation 601, the electronic device can determine whether another animation that is being played in the electronic device exists. For example, the processor 120 can determine if another animation that is being played on the display 160 exists at a time point for playing the animation corresponding to the attribute of the loop item.

In case where the another animation that is being played in the electronic device exists, in operation 603, the electronic device can determine if the animation of the loop item of which the selection input is detected is available to be played. For example, the processor 120 can compare the priority order of the loop item of which the selection input is detected and the loop item of which the animation is being played, and determine if it can play the animation of the loop item of which the selection input is detected. For instance, in case where the priority order of the loop item of which the selection input is detected is higher relatively, the processor 120 can select, as an animation for playing, the animation of the loop item of which the selection input is detected. For example, the priority order of the loop item can be determined based on at least one of a performance attribute of the loop item and a selection sequence of the loop item. For instance, the processor 120 can highest set the priority order of a loop item to which a continuous play is set, and lowest set the priority order of a loop item to which a repeat play is set. For instance, in case where the priority order by the performance attribute are the same as each other, the processor 120 can highest set the priority order of a loop item that is latest selected.

In case where the another animation that is being played in the electronic device does not exist (operation 601), or the animation of the loop item of which the selection input is detected is available to be played (operation 603), in operation 605, the electronic device can play a sound sample registered to the loop item and the animation corresponding to the attribute of the loop item. For example, the processor 120 can output the sound sample registered to the loop item of which the selection input is detected, through an audio processing module (not shown) of the electronic device 101. The processor 120 can output through the display 160 the animation of the loop item to correspond to a time point of playing of the sound sample registered to the loop item. For instance, the processor 120 can display the animation of the loop item in synchronization with the time point of playing of the sound sample registered to the loop item. In other words, the processor 120 can display the animation of the loop item through the display 160 at the same time point as the time point of playing of the sound sample registered to the loop item.

In case where the electronic device cannot play the animation of the loop item of which the selection input is detected, in operation 607, the electronic device can play the sound sample registered to the loop item. For example, the processor 120 can output the sound sample registered to the loop item of which the selection input is detected, through the audio processing module (not shown) of the electronic device 101. In this case, the processor 120 can output an animation of another loop item (e.g., loop item of which priority order is high) through the display 160.

In operation 609, the electronic device can determine if the playing of the sound sample for the loop item of which the selection input is detected is ended. For example, in case where the performance attribute of the sound sample corresponding to the attribute of the loop item is a single play or a resume play, the processor 120 can determine if the playing of the sound sample corresponding to the attribute of the loop item is terminated. For example, in case where the performance attribute of the sound sample corresponding to the attribute of the loop item is a continuous play, the processor 120 can determine if an input (e.g., touch input) for the loop item is released. For example, in case where the performance attribute of the sound sample corresponding to the attribute of the loop item is the single play or a repeat play, the processor 120 can determine if an input for the ending of the playing of the sound sample corresponding to the attribute of the loop item is detected.

In case where the playing of the sound sample for the loop item of which the selection input is detected is not ended, in operation 601, the processor 120 can again determine if another animation that is being played in the electronic device exists.

According to various embodiments, in case where the electronic device detects a selection of a plurality of loop items, the electronic device can determine an animation of each loop item. In this case, the electronic device can select an animation for playing, based on the priority order of the loop item. For example, the electronic device can select, as the animation for playing, an animation of a loop item of which priority order is relatively high among the plurality of loop items of which the selection input is detected.

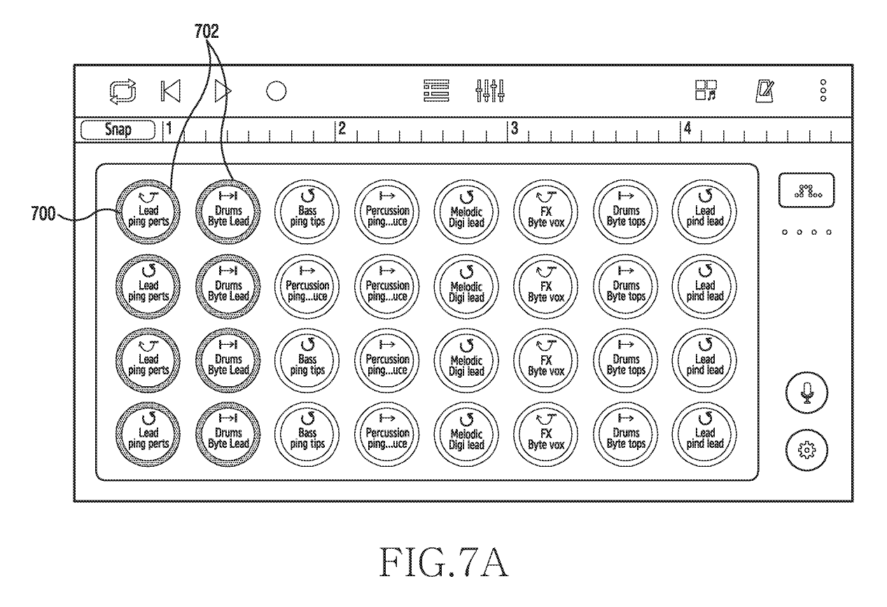

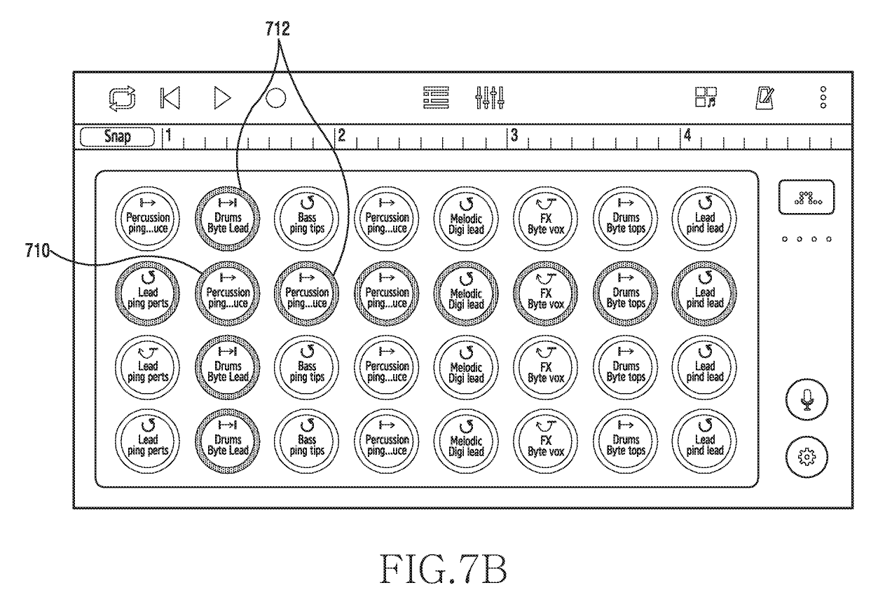

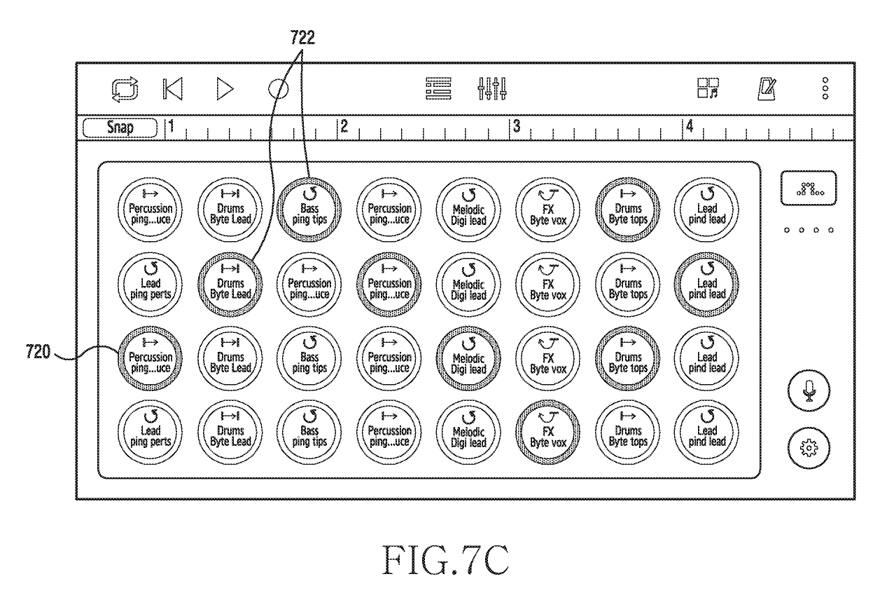

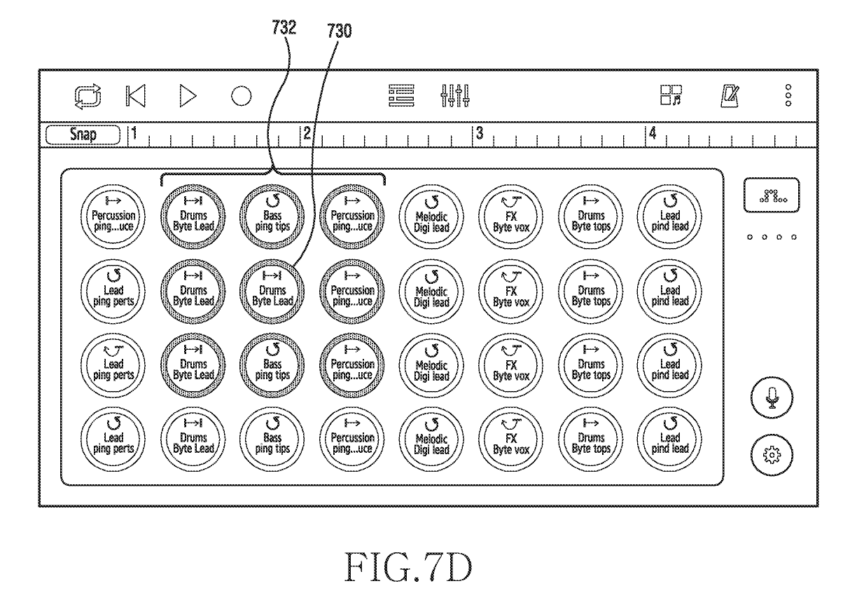

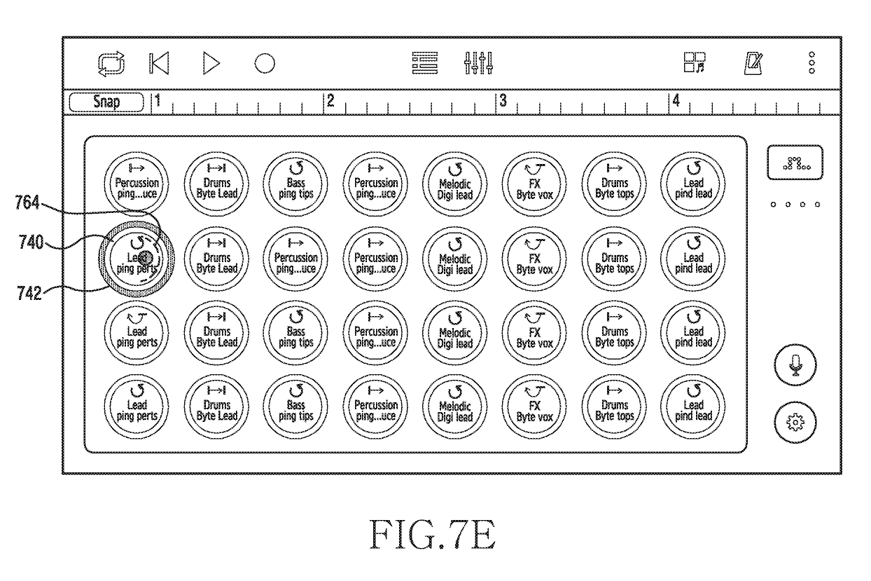

FIGS. 7A, 7B, 7C, 7D, and 7E illustrate animation effects of loop items according to various embodiments of the present disclosure. The following description illustrates a screen construction for playing the animation effect corresponding to an attribute of the loop item in an electronic device.

Referring to FIG. 7A, in case where a performance attribute of a loop item 700 of which a selection input is detected is a resume play, the electronic device can play an animation effect of which a graphic attribute is for appearing to sequentially spread from the loop item 700 to other loop items 702 included in a rectangular shape. For example, the electronic device can provide the animation effect of which the graphic attribute is for appearing to spread to the other loop items 702 at a speed corresponding to a length of a sound sample registered to the loop item 700. For instance, the graphic attribute can include at least one of a color of a loop item, a shadow thereof, a contour line thereof, and a color of the contour line. The processor 120 can apply a mutually different graphic attribute on a per-loop-item basis and play an animation effect.

Referring to FIG. 7B, in case where a performance attribute of a loop item 710 of which a selection input is detected is a continuous play, the electronic device can play an animation effect of which a graphic attribute is for appearing to sequentially spread from the loop item 710 to other loop items 712 included in a cross shape. For example, the electronic device can provide the animation effect of which the graphic attribute is for appearing to spread to the other loop items 712 at a speed corresponding to a length of a sound sample registered to the loop item 710.

Referring to FIG. 7C, in case where a performance attribute of a loop item 720 in which a selection input is detected is a continuous play, the electronic device can play an animation effect of which a graphic attribute is for appearing to sequentially spread from the loop item 720 to other loop items 722 included in a diagonal shape. For example, the electronic device can provide the animation effect of which the graphic attribute is for appearing to spread to the other loop items 722 at a speed corresponding to a length of a sound sample registered to the loop item 720.

Referring to FIG. 7D, in case where a performance attribute of a loop item 730 of which a selection input is detected is a single play, the electronic device can play an animation effect of which a graphic attribute is for appearing to sequentially spread from the loop item 730 to other loop items 732 included in a square shape. For example, the electronic device can provide the animation effect of which the graphic attribute is for appearing to spread to other loop items 732 at a speed corresponding to a length of a sound sample registered to the loop item 730.

Referring to FIG. 7E, in case where a performance attribute of a loop item 740 of which a selection input is detected is a repeat play, the electronic device can play an animation effect of changing a graphic attribute 742 of the loop item 740. For example, the electronic device can change the graphic attribute 742 of the loop item 740 at a speed corresponding to a length of a sound sample registered to the loop item 740. Additionally, the electronic device can display a user interface 764 repeatedly displayed corresponding to a length (bit) of a sound sample within the loop item 740. For instance, in case where the length of the sound sample registered to the loop item 740 is 4 bits, the electronic device can quadrisect the circumference of the loop item 740 and display a playing period of the sound sample.

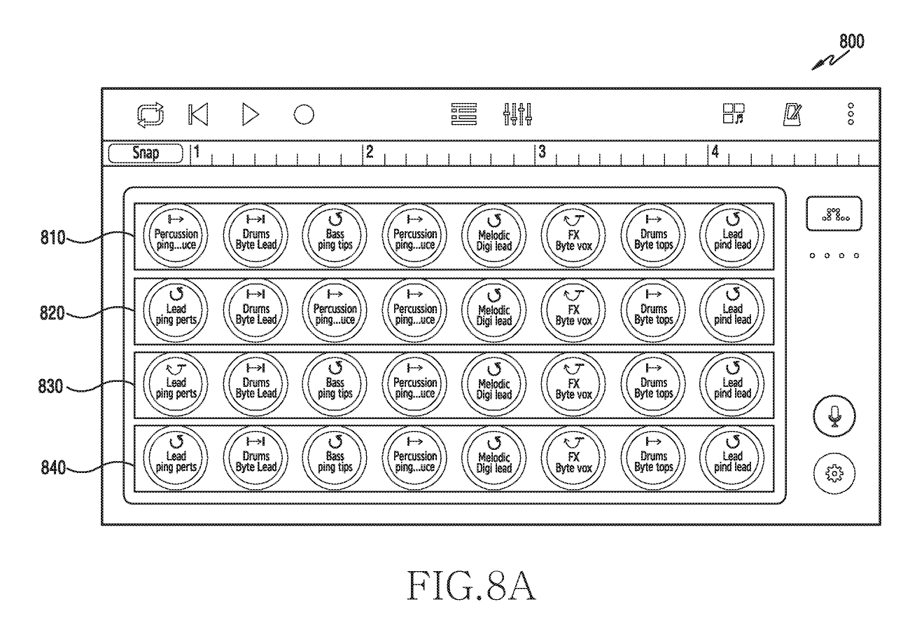

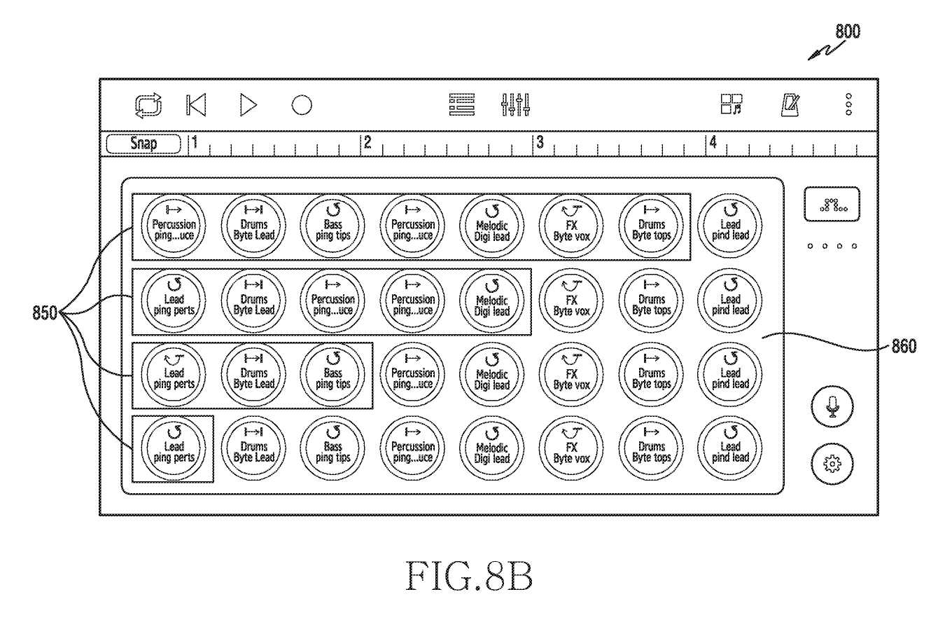

FIGS. 8A and 8B illustrate groups of loop items for applying animation effects according to various embodiments of the present disclosure.

According to an embodiment of the present disclosure, the electronic device can set an animation of a loop item by group of loop items. Referring to FIG. 8A, the electronic device can set the same animation to loop items that include the same performance attribute in the same row 810, 820, 830 or 840 in a lattice structure constructing a loop region screen 800. For instance, the electronic device can set the same animation to loop items of a continuous play in the 1st row 810 of the loop region screen 800. The electronic device can set the same animation to the loop items of the continuous play in the 3rd row 830 of the loop region screen 800. Additionally, the electronic device can differently set a starting position of the animation and a playing scheme of the animation in accordance with a position of the loop item and a length of a sound sample registered to the loop item.

According to an embodiment of the present disclosure, the electronic device can set an animation of a loop item to be redundant by group of loop items. Referring to FIG. 8B, the electronic device can set an animation corresponding to a performance attribute by loop item that is included in a 1st group 850 with a criterion of a diagonal line in a lattice structure constructing a loop region screen 800. In case where a performance attribute of a loop item of a 2nd group 860 is the same as a performance attribute of a loop item existing in a position corresponding to the 1st group 850, the electronic device can set an animation of the loop item of the 2nd group 860 identically with the animation of the loop item of the 1st group 850. Additionally, the electronic device can differently set a starting position of the animation and a playing scheme of the animation in accordance with a position of the loop item and a length of a sound sample registered to the loop item.

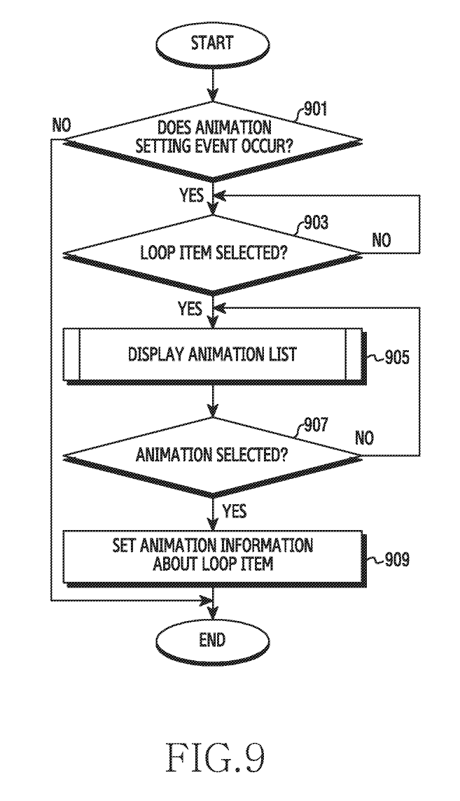

FIG. 9 illustrates a flowchart for setting an animation of a loop item in an electronic device according to an embodiment of the present disclosure. The following description is made for an operation for setting the animation of the loop item in the electronic device. In the following description, the electronic device can include the electronic device 101 of FIGS. 1A and 1B or at least a part (e.g., processor 120) of the electronic device 101.

Referring to FIG. 9, in operation 901, the electronic device can determine if an event for setting an animation of a loop item takes place. For example, the processor 120 can determine if a selection input (e.g., touch input) of an animation setting item displayed on the display 160 is detected through the input output interface 150. For example, the processor 120 can determine if a gesture input to which the event for setting the animation of the loop item is mapped is detected through a sensor (not shown) of the electronic device 101. For instance, the sensor can include a gesture sensor, a gyro sensor, an acceleration sensor, a proximity sensor, and the like. For example, the processor 120 can determine if a voice command to which the event for setting the animation of the loop item is mapped is detected through the input output interface 150.

In case where the event for setting the animation of the loop item occurs, in operation 903, the electronic device can determine if the loop item for setting the animation is selected. For example, in case where the event for setting the animation of the loop item takes place, the processor 120 can display a list of loop items capable of setting an animation, through the display 160. In this case, the processor 120 can determine if a selection input of a loop item for setting an animation in the list of loop items displayed on the display 160 is detected through the input output interface 150. For example, in case where the event for setting the animation of the loop item occurs, the processor 120 can display the loop region screen 300 through the display 160 as in FIG. 3. In this case, the processor 120 can determine if a selection input of a loop item for setting an animation in the loop region screen 300 displayed on the display 160 is detected through the input output interface 150.

In case where the electronic device selects the loop item for setting the animation, in operation 905, the electronic device can display a list of animations that are available to be set to the loop item on the display. For example, the processor 120 can select at least one animation corresponding to an attribute of the loop item from among preset animations stored in the memory 130. The processor 120 can determine the at least one animation corresponding to the attribute of the loop item, as an animation that is available to be set to the loop item, and display the at least one animation on the display 160.

In operation 907, the electronic device can determine if an animation that is available to be set to the loop item is selected among the at least one animation included in the animation list. For example, the processor 120 can determine if a selection input (e.g., touch input) of the animation that is available to be set to the loop item in the animation list displayed on the display 160 is detected through the input output interface 150.

In case where the animation that is available to be set to the loop item is not selected, the electronic device can return to operation 905 and maintain the displaying of the animation list. For example, in case where the animation that is available to be set to the loop item is not selected until a time point at which a criterion time lapses from a time point of displaying the animation list, the processor 120 can determine not to set the animation of the loop item. Accordingly to this, the processor 120 can terminate the present algorithm for setting the animation of the loop item.

In case where the animation that is available to be set to the loop item is selected, in operation 909, the electronic device can set the animation selected from the animation list, as the animation of the loop item. For example, the processor 120 can set an animation on which a touch input is detected in the animation list displayed on the display 160, as the animation corresponding to an attribute of the loop item selected in operation 903. The processor 120 can store animation information corresponding to the attribute of the loop item in the memory 130 or external device (e.g., server).

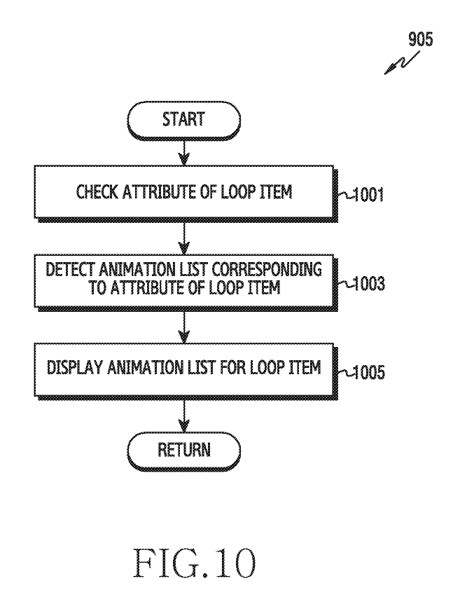

FIG. 10 illustrates a flowchart for providing an animation list corresponding to a loop item in an electronic device according to an embodiment of the present disclosure. The following description is made for an operation for displaying the animation list in operation 905 of FIG. 9. In the following description, the electronic device can include the electronic device 101 of FIGS. 1A and 1B or at least a part (e.g., processor 120) of the electronic device 101.

Referring to FIG. 10, in case where the electronic device selects a loop item for setting an animation (e.g., operation 903 of FIG. 9), in operation 1001, the electronic device can determine an attribute of the loop item for setting the animation. For example, the processor 120 can detect a position of the loop item that is selected to set the animation in a lattice array of loop items included in the loop region screen 300 of FIG. 3. For example, the processor 120 can detect at least one of a performance attribute of the loop item for setting the animation and a length of a sound sample registered to the loop item.

In operation 1003, the electronic device can detect an animation list corresponding to the attribute of the loop item for setting the animation. For example, the processor 120 can select at least one animation corresponding to the attribute of the loop item from among animations previously stored in the memory 130, such that it can be set to the loop item.

In operation 1005, the electronic device can display on the display 160 a list of animations corresponding to the attribute of the loop item for setting the animation. For example, the processor 120 can control the display 160 to display the animation list including at least one animation corresponding to the attribute of the loop item.

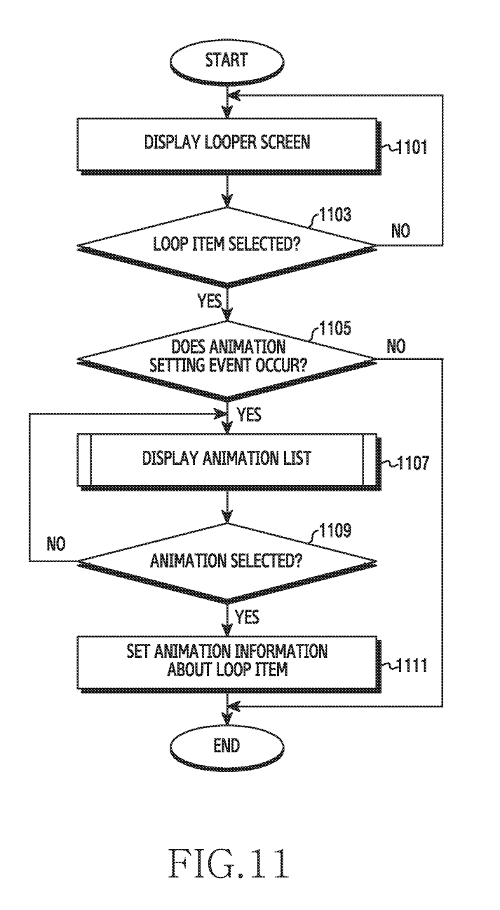

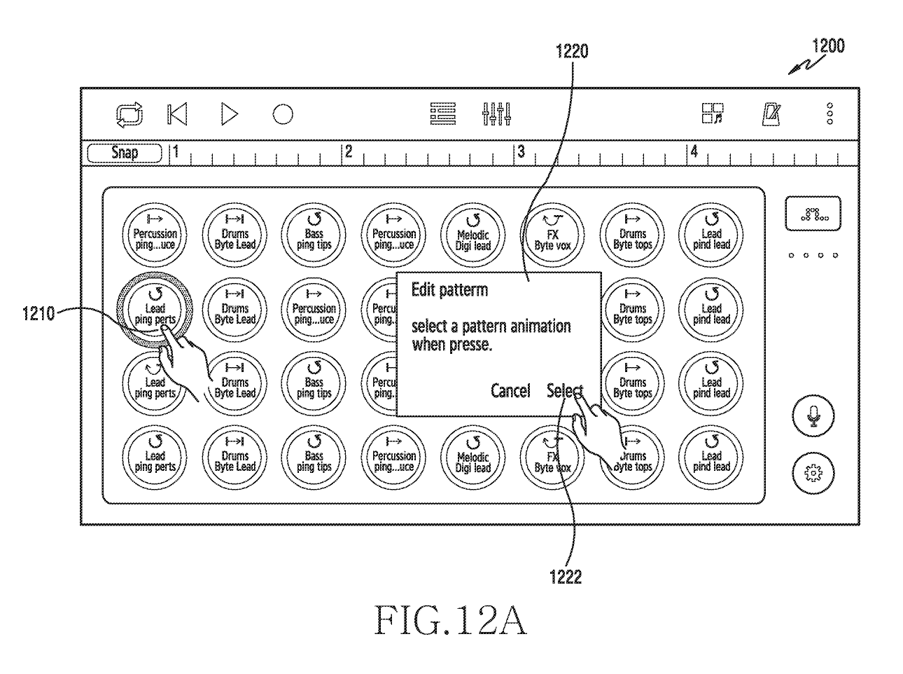

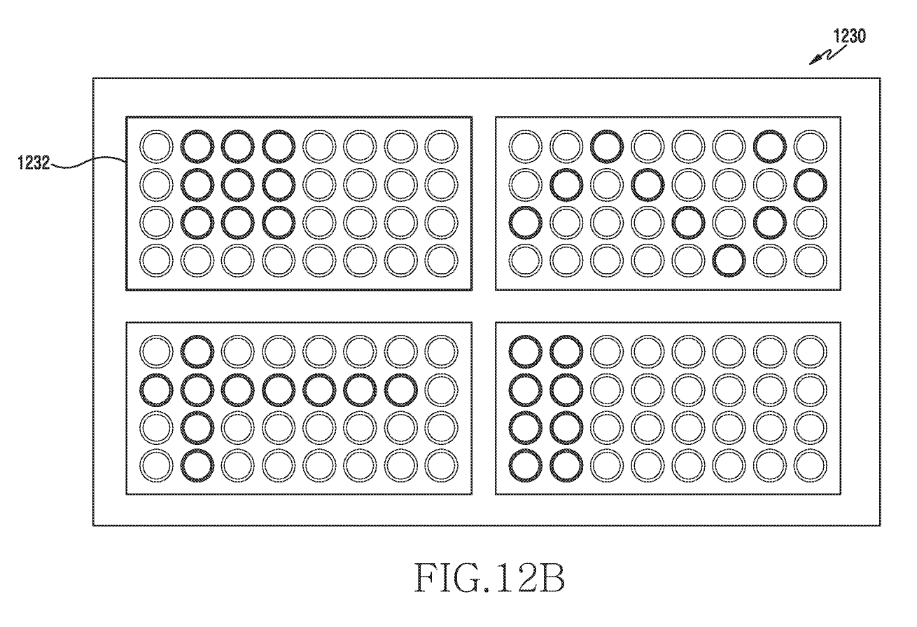

FIG. 11 illustrates a flowchart for setting an animation of a loop item in an electronic device according to an embodiment of the present disclosure. The following description is made for an operation for setting the animation of the loop item the electronic device with reference to screen constructions of FIGS. 12A and 12B.

FIGS. 12A and 12B illustrate the screen constructions for setting the animation of the loop item in the electronic device according to various embodiments of the present disclosure. In the following description, the electronic device can include the electronic device 101 of FIGS. 1A and 1B or at least a part (e.g., processor 120) of the electronic device 101.

Referring to FIG. 11, in operation 1101, the electronic device can display on the display a loop region screen for performing a loop region function. For example, in case where an event corresponding to loop region function execution occurs, the processor 120 can display a loop region screen 1200 including a plurality of loop items on the display 160 as in FIG. 12A.

In operation 1103, the electronic device can determine if at least one loop item is selected from the loop region screen displayed on the display of the electronic device. Referring to FIG. 12A, in case where a touch input on the loop region screen 1200 displayed on the display 160 is detected, the processor 120 can determine if a touch input on a loop item 1210 has been detected.

In case where the loop item is not selected, the electronic device can return to operation 1101 and maintain the displaying of the loop region screen for performing the loop region function.

In case where the loop item is selected, in operation 1105, the electronic device can determine if an animation setting event for the corresponding loop item occurs. Referring to FIG. 12A, the processor 120 can determine if a touch input on the loop item 1210 of the loop region screen 1200 displayed on the display 160 is held during a criterion time. For instance, in case where the touch input on the loop item 1210 is maintained during the criterion time, the processor 120 can determine if the animation setting event occurs. For example, as in FIG. 12A, the processor 120 can determine if a selection input of an icon corresponding to the animation setting event in the loop region screen 1200 displayed on the display 160 is detected. For instance, in case where the selection input of the icon corresponding to the animation setting event is detected, the processor 120 can determine that the animation setting event occurs.

In case where the electronic device detects the occurrence of the animation setting event, in operation 1107, the electronic device can display an animation list of the loop item of which the selection input is detected, on the display. For example, as in operation 1001 to operation 1005 of FIG. 10, the processor 120 can display on the display 160 at least one animation corresponding to an attribute of the loop item. For instance, as in FIG. 12A, in case where the processor 120 detects the occurrence of the animation setting event, the processor 120 can display a message 1220 for determining animation setting or non-setting on the display 160. In case where an input of a “select” menu 1222 in the message 1220 for determining the animation setting or non-setting is detected, as in FIG. 12B, the processor 120 can display an animation list 1230 corresponding to the attribute of the loop item on the display 160.

In operation 1109, the electronic device can determine if an animation to be set to the loop item is selected among at least one animation included in the animation list. For example, as in FIG. 12B, the processor 120 can select an animation 1232 to be set to the loop item, based on a touch input on the animation list 1230 displayed on the display 160. For instance, the processor 120 can determine if the animation 1232 mapped to a position (e.g., coordinate) of a touch input detected through the input output interface 150 exists among animations included in the animation list 1230 displayed in the loop region screen 1200.

In case where the animation to be set to the loop item is not selected, the electronic device can return to operation 1107 and maintain the displaying of the animation list. For example, in case where the touch input on the animation list is not detected until a criterion time lapses from a time point of displaying the animation list, the processor 120 can determine not to set an animation of the loop item. Accordingly to this, the processor 120 can terminate the present algorithm for setting the animation of the loop item.

In case where the animation to be set to the loop item is selected, in operation 1111, the electronic device can set the animation selected from the animation list, as the animation of the loop item. For example, as in FIG. 12B, the processor 120 can set the animation 1232 on which the touch input is detected in the animation list 1230 displayed on the display 160, as the animation corresponding to the loop item (e.g., loop item selected in operation 1103) of which the selection input is detected. The processor 120 can store animation information corresponding to the attribute of the loop item in the memory 130 or external device (e.g., a server).

According to various embodiments of the present disclosure, the electronic device can be provided with a predefined animation available to be set as an animation of a loop item, from the external device (e.g., server). For example, the processor 120 can receive animation information available to be set as the animation of the loop item, from the external device through the communication interface 170, and store the animation information in the memory 130. For instance, the animation information can include graphic attribute information of the loop item for applying an animation effect.

An electronic device and an operation method thereof according to various embodiments can improve a use efficiency of a touch screen and improve a user's convenience, by playing a sound sample of a loop item displayed on a display of the electronic device and an animation corresponding to an attribute (e.g., a position, a performance attribute and a sound sample) of the loop item.

An electronic device and an operation method thereof according to various embodiments can provide various visual effects to a user through a looper function, by setting an animation corresponding to an attribute of a loop item based on a user input.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable storage medium may be, for example, the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display configured to display a looper screen that comprises a plurality of loop items;
a memory configured to store a plurality of sound samples corresponding to the loop items; and
at least one processor configured to:
select at least one loop item from among the plurality of loop items displayed on the display,
determine an animation corresponding to an attribute of the selected at least one loop item, and
control to the display to display the animation corresponding to the attribute of the selected at least one loop item.

2. The electronic device of claim 1, wherein the processor is further configured to play a sound sample assigned to the selected at least one loop item.

3. The electronic device of claim 2, wherein the processor is further configured to play the animation corresponding to the attribute of the selected at least one loop item synchronized with the sound sample assigned to the selected at least one loop item.

4. The electronic device of claim 1, wherein the processor is further configured to select at least one animation corresponding to the attribute of the selected at least one loop item from among a plurality of animations stored in the memory.

5. The electronic device of claim 1, wherein the attribute of the loop item comprises at least one of:
a position of the loop item in the looper screen,
a length of a sound sample assigned to the loop item, or
a performance attribute of the loop item.

6. The electronic device of claim 1, wherein the processor is further configured to:
select at least one animation corresponding to a performance attribute of the selected at least one loop item from among a plurality of animations stored in the memory,
update the at least one animation to correspond to a position of the selected at least one loop item, and
determine a playing scheme of the at least one animation to correspond to a length of a sound sample assigned to the selected at least one loop item.

7. The electronic device of claim 1, wherein the processor is further configured to change a graphic attribute of at least one loop item from among a plurality of animations in the looper screen to correspond to the animation corresponding to the attribute of the selected at least one loop item.

8. The electronic device of claim 1, wherein the processor is further configured to:
select, if the determined animations correspond to attributes of the plurality of loop items, any one animation based on a priority order of the loop items, and
control the display to display the any one animation selected based on the priority order of the loop items.

9. The electronic device of claim 8, wherein the priority order of the loop item is determined by at least one of:
a performance attribute of the loop item, or
a selection sequence of the loop item.

10. A method for operating in an electronic device, the method comprising:
displaying a looper screen that comprises a plurality of loop items;
selecting at least one loop item from among the plurality of loop items displayed on the looper screen;
determining an animation corresponding to an attribute of the selected at least one loop item; and
playing the animation corresponding to the attribute of the selected at least one loop item.

11. The method of claim 10, further comprising playing a sound sample assigned to the selected at least one loop item.

12. The method of claim 11, wherein the playing of the animation comprises playing the animation corresponding to the attribute of the selected at least one loop item synchronized with the sound sample assigned to the selected at least one loop item.

13. The method of claim 10, wherein the determining of the animation comprises selecting at least one animation corresponding to the attribute of the selected at least one loop item from among a plurality of animations stored in a memory of the electronic device.

14. The method of claim 10, wherein the attribute of the loop item comprises at least one of:
a position of the loop item in the looper screen,
a length of a sound sample assigned to the loop item, or
a performance attribute of the loop item.

15. The method of claim 10, wherein the determining of the animation comprises:
selecting at least one animation corresponding to a performance attribute of the selected at least one loop item from among a plurality of animations stored in a memory of the electronic device;
updating the at least one animation to correspond to a position of the selected at least one loop item; and
determining a playing scheme of the at least one animation to correspond to a length of a sound sample assigned to the selected at least one loop item.

16. The method of claim 10, wherein the playing of the animation comprises changing a graphic attribute of at least one loop item from among a plurality of animations in the looper screen to correspond to the animation corresponding to the attribute of the selected at least one loop item.

17. The method of claim 10, wherein the playing of the animation comprises:
selecting, if the determined animations correspond to attributes of the plurality of loop items, any one animation based on a priority order of the loop items; and
playing the any one animation selected based on the priority order of the loop items.

18. The method of claim 17, wherein the priority order of the loop item is determined by at least one of:
a performance attribute of the loop item, or
a selection sequence of the loop item.

19. An electronic device comprising:
a display configured to display a looper screen that comprises a plurality of loop items;
a memory configured to store a plurality of animations available to be set to the loop items; and
at least one processor configured to:
select any one loop item from among the plurality of loop items displayed on the display,
determine at least one animation corresponding to an attribute of the selected any one loop item, and
set any one animation among the at least one animation, as an animation corresponding to the attribute of the loop item.

20. The electronic device of claim 19, wherein the attribute of the loop item comprises at least one of:
a position of the loop item in the looper screen,
a length of a sound sample assigned to the loop item, or
a performance attribute of the loop item.
